(19) United States
(12) Patent Application Publication
(10) Pub. No.: US 2026/0156104 A1
(43) Pub. Date: Jun. 4, 2026

(54) METHOD AND SYSTEM FOR DOCUMENTING LOGBOOK DATA BY ONE OR MORE FIRST FIELD DEVICES

(71) Applicant: Endress+Hauser Process Solutions AG, Reinach (CH)

(72) Inventors: Thomas Alber, Stuttgart (DE); Patrice Grosperrin, Rixheim (FR); Björn Haase, Stuttgart (DE); Michael Kuhl, Haldenwang (DE); Tobias Paul, chopfheim (DE); Axel Pöschmann, Basel (CH); Johannes Sprenger, Lörrach (DE)

(21) Appl. No.: 19/131,002

(22) PCT Filed: Oct. 20, 2023
(86) PCT No.: PCT/EP2023/079312

§ 371 Date: May 19, 2025

(30) Foreign Application Priority Data
Nov. 17, 2022 (DE) 10 2022 130 426.4

(51) Int. Cl. H04L 9/40; H04L 9/30; H04L 9/32

(52) U.S. Cl. CPC H04L 63/0435; H04L 9/3073; H04L 9/3273; H04L 63/0442

(57) ABSTRACT

Documenting logbook data by one or more first field device, wherein each of the first field devices has a first resource power, wherein a second field device is provided with a second resource power is provided. The second resource power is greater than the first resource powers, wherein each of the first field devices continuously generates corresponding logbook data that contains security-relevant data and/or data relating to the operation of the corresponding first field device, said method comprising: establishing a secure communication link between one or more of the first field devices and the second field device; transmitting the current logbook data from the first field device or each of the first field devices at predetermined times via the communication link; accumulating the current logbook data by the second field device and storing the accumulated logbook data in a memory unit of the second field device, and a corresponding system.

The invention relates to a method for documenting logbook data by one or more first field devices, wherein each of the first field devices has a first resource power, wherein a second field device is provided with a second resource power, wherein the second resource power is greater than each of the first resource powers, wherein each of the first field devices continuously generates corresponding logbook data, wherein the logbook data contain in particular safety-relevant data and/or data relating to the operation of the corresponding first field device/″. Furthermore, the invention relates to a system comprising one or more first field devices of automation technology and a second field device of automation technology.

Field devices that are used in industrial installations are already known from the prior art. Field devices are often used in process automation technology, as well as in manufacturing automation technology. In principle, all devices which are process-oriented and which supply or process process-relevant information are referred to as field devices. Field devices are thus used for detecting and/or influencing process variables. Measuring devices, or sensors, are used for detecting process variables. They are used, for example, for pressure and temperature measurement, conductivity measurement, flow measurement, pH measurement, fill level measurement etc., and detect the corresponding process variables of pressure, temperature, conductivity, pH value, fill level, flow, etc. Actuators are used for influencing process variables. These actuators are, for example, pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level.

Many areas of application in which the field devices described above are used are characterized by increased safety requirements. Examples include the pharmaceutical industry or critical infrastructure such as nuclear power plants or drinking water supplies. One of the key tasks in this respect is the reliable verification and documentation of the plant status, a so-called audit trail, from which the plant status and changes in the operating settings, for example during the production of a batch of a drug, can be subsequently tracked.

A multitude of such field devices is produced and marketed by the Endress+Hauser group.

In modern industrial plants, field devices are usually connected to superordinate units via communications networks such as fieldbuses (Profibus®, Foundation® Fieldbus, HART®, etc.). Only in exceptional cases are interfaces used that have inherent network capability, e.g., based on Internet protocols. Recently, field devices have also increasingly been equipped with short-range radio systems, such as Bluetooth or systems in accordance with the IEEE 802.15.4 standard. For the purposes of the present disclosure, a distinction is made between network-capable wide area network (WAN) communication interfaces on the one hand (e.g., based on Internet protocols) and local communication interfaces (e.g., short-range radio or traditional fieldbus systems without network data switching).

Normally, the superordinate units are control systems (DCS) or control units, such as a PLC (programmable logic controller), which generally do not allow a WAN data connection to field devices. The superordinate units are used for, among other things, process control, process visualization, and process monitoring, as well as commissioning of the field devices. The interfaces and interface protocols are generally not necessarily network-capable. For security reasons, security-relevant networks in particular are deliberately separated from wide-area networks such as the Internet in order to prevent possible external attacks.

The measured values recorded by the field devices, especially by sensors, are transmitted via the respective bus system to a (or in some cases a plurality of) superordinate unit(s). In addition, data transmission from the superordinate unit via the bus system to the field devices is also required, especially for configuration and parameterization of field devices and for controlling actuators.

For field devices, there is an increasing need for protection against manipulation in the sense of the English term “security,” in addition to protection in the sense of the English term “safety.” An essential component of this is the secure and tamper-proof storage of device information in logbooks.

The following aspects are important with regard to the data to be securely archived:
a tamper-proof filing system that prevents subsequent manipulation of crucial information, for example in the event of a system fault;
a readout time required to transmit the data, or the transmission speed available on a communication interface; and
a size of a persistent memory required for archiving.

In the run-up to an attack, it is unclear which information needs to be monitored for later analysis and for which time relevant data will be needed at a later time. It is therefore desirable to monitor the device status continuously, comprehensively, and permanently. However, this can result in very large amounts of data being generated over operating periods of up to several years. These amounts of data can become problematic to the extent that the storage capacity exceeds the resources of a device. On the other hand, even if a large memory is available in a device, the transmission speed on the interfaces can become a limiting factor if, for example, the transmission of the logbook contents requires several hours.

These aspects pose technical challenges for many field devices, especially small, low-cost ones, because they, for example, only contain low-speed communication interfaces and/or small memories. With regard to long-term tamper resistance, the risk of compromise of the cryptographic keys used to protect the logbook contents must also be taken into account, in particular in the case in which the field device does not have special security chipsets (so-called secure elements), which, for example, allow keys for secure checksums/signatures to be stored in a read-proof manner and cryptographic calculations to be performed with side-channel protection. Without such specialized security chipsets, it may not be possible to ensure that the risk of so-called compromised keys can be managed even when using keys with long validity periods (“long-term keys”).

Server solutions for archiving data, e.g., on a PC in a server rack in a data center, are known in the prior art. However, these solutions often cannot be used in an industrial context because WAN network connections to the field devices are not permitted, with the aim of preventing external attacks by a so-called wire gap, or because the fieldbus interfaces do not support external network connections to a logbook archiving server in a data center.

Key-based checksum methods for protecting data are also known. Based on the keys used, a distinction can be made between symmetric checksums (e.g., HMAC-SHA256, so-called keyed hashes or message authentication codes) on the one hand and asymmetric checksums or signatures (e.g., ECDSA, EdDSA) on the other hand. Symmetric checksums are both generated and verified with the same symmetric key, while asymmetric checksums use a private key of a key pair for generation and a public key of the key pair for verification.

In the present disclosure, it is relevant that the computing power required to generate an asymmetric checksum (signature) may exceed the computing resources of a small field device. This applies in particular to the case of so-called post-quantum algorithms, which cannot be broken cryptoanalytically even by means of quantum computers that may become available in the future. In this respect, new security standards are currently being developed that meet increased requirements but have increased computing power and storage requirements in comparison to previous methods (in particular those based on the RSA method or elliptic curves). Examples of such post-quantum algorithms are hash-based signatures, code-based methods such as McElice, isogeny methods on elliptic curves, and methods based on discrete grids. Competitions in this respect are currently underway, including at the American NIST standards authority.

Often, critical system components in particular are deliberately installed in completely separate subnets, which, for example, do not allow a direct network data connection to a server room because there is no physical cable connection. Locally in the subnet, only communication of the field devices with one another, but not with external server components, may then be possible. In the case of field devices with short-range radio (such as Bluetooth), the short-range radio may make possible a data connection between the field devices installed locally in a part of the system, for example from one field device to a neighboring field device, but, due to the distance, not a direct radio communication to a system control center in the server room.

Fieldbus and radio data connections that are locally networked over short distances generally also differ in terms of quality features, such as availability and maximum downtimes during maintenance or software updates, from conventional WAN networks, as are increasingly also set up via long-distance radio over mobile networks (e.g., according to the so-called 4G and 5G standards). It is important to note that local data communication from one field device to a neighboring field device can generally be considered more reliable than a connection to servers, which requires the use of WAN networks.

Many plant operators today define security policies (for example, designed as a zone concept) in which field devices are not allowed to have direct access outside the automation system or sub-system (or its assigned zone). However, low-performance devices must still store their security-relevant data (e.g., information about user login, change histories, etc.) and/or intellectual property information (e.g., process-related sensor measurement data, sensor sample data, sensor curves, etc.) in a secure memory in an auditable and trackable manner. One possible security concept for connecting a local network to a WAN network is the use of a so-called data diode, where information can only be sent unidirectionally from the local network to the WAN, but no data can be received from the WAN network.

It should also be taken into account that, for cost reasons, only limited resources can be reserved for simple sensors (e.g., a cost-optimized temperature sensor reduced to basic functionality).

Based on this problem, the invention is based on the object of presenting a method which makes secure archiving of logbook data in systems possible, even including field devices with low resources.

The object is achieved by a method for documenting logbook data by one or more first field devices, wherein each of the first field devices has a first resource power, wherein a second field device is provided with a second resource power, wherein the second resource power is greater than each of the first resource powers, wherein each of the first field devices continuously generates corresponding logbook data, wherein the logbook data contain security-relevant data and/or data relating to the operation of the corresponding first field device, comprising:
establishing a secure, i.e., authenticated, integrity-checked and, if appropriate, encrypted communication link between one or more of the first field devices and the second field device;
transmitting the current logbook data from the first field device or each of the first field devices continuously or at predetermined times via the communication link;
accumulating the current logbook data by the second field device and storing the accumulated logbook data in a memory unit of the second field device.

According to the invention, it is therefore proposed to continuously transmit the logbook data of first field devices with weaker resources to a second field device with stronger resources during operation, which second field device continuously aggregates and collects the logbook data in its, in particular persistent, memory, and makes them available to a user for analysis as needed. The first field devices in particular have communication interfaces which make significantly slower data communication possible in comparison to the communication interfaces of the second field device. However, since the amount of logbook data to be transmitted from the first field devices is relatively small, for example approximately 1 kByte per minute, the communication interfaces usually present in the first field devices are sufficient to transmit the logbook data to the second field device; in this case, however, the amount of data of 500 megabytes accumulating over the course of a year, for example, could neither be stored in the first field devices nor read out via their slower communication interfaces.

Examples of field devices mentioned in connection with the method according to the invention are described in the introductory part of the description.

The term “safety” in the sense of the present invention encompasses both the dimension of operational safety and also security with regard to accidental or intentional manipulation.

In the sense of the present application, the term “resource power” is understood to mean the combination of the features of a limited capacity of a persistent data memory (e.g., EEPROM or flash memory module) and/or the limited capacity of the available communication interfaces and/or the available computing power and/or the ability to store cryptographic key information in a read-proof manner over a longer period of time.

The first field devices are resource-limited field devices, which are, for example, temperature transmitters, which are equipped, for example, with a HART fieldbus (nominal communication bandwidth on the order of approximately 50 bytes per second transmission speed) or a Bluetooth Low Energy interface (possibly on the order of approximately 200 bytes per second transmission speed), which are typically operated by a 12-volt power supply at 3.5 mA current intensity.

In comparison to the first field devices, the second field device is a more resource-intensive field device, which in particular has a larger memory, faster communication interfaces, and/or a more powerful power supply. In particular, the second field device is suitable for the installation of secure security chipsets (so-called secure elements, SE). Examples of such second field devices are “recorder” devices or larger flow meters that are powered, for example, by a 230 V or 24 V power supply with, for example, a power of 20 W and, in addition to slower Bluetooth Low Energy or HART communication interfaces, may also have fast WLAN or Ethernet interfaces.

Advantageously provided are the further steps of:
additional protection of the accumulated logbook data using the means of the second field device (e.g., additional checksums generated by the second field device);
secure provision of the accumulated logbook data by the second field device to an authorized evaluation unit or to a user; and
checking the logbook data (e.g., against manipulation).

One embodiment of the method provides for the secure communication link to be implemented based on a key. Here, a symmetric key pair is used to establish a secure communication link between the first and the second field device, with this key being located on both field devices.

Alternatively, an asymmetric key pair consisting of a private key and a public key is used to establish a secure communication link, wherein the private key of the symmetric key pair is located on the corresponding field device and the public key of the symmetric key pair is located on the communication partner.

It can be provided here to establish the basis of trust for establishing the communication link (i.e., which public keys are trustworthy) by using a public key infrastructure.

Various methods for establishing a secure connection are known from the prior art (for example, according to the TLS standard), wherein securing usually initially comprises a one-way or two-way authenticity check of the communication partners on the basis of the above-mentioned symmetric or asymmetric key information, and then, if successful, the negotiation of a session key.

In an advantageous embodiment of the method, it is provided that each of the first field devices provides its current logbook data with a checksum before the transmission to the second field device, which checksum is calculated from the current logbook data and optionally a further key. Advantageously, the second field device aggregates the received current logbook data of each of the first field devices only if the checksum can be successfully verified.

In an advantageous embodiment of the method, it is provided that the logbook data then also located in the memory unit of the second field device are provided with an additional second checksum by the second field device. The advantage of this second checksum is that, for this purpose, the second field device can use better-protected keys (for example, when using a secure element chipset) or better-protected, more computationally intensive methods, which may not be able to be used in the first field device due to its limited resources.

In an advantageous embodiment of the method, it is provided that the logbook data located in the memory unit of the second field device are output by the second field device to a user or are retrieved by a user from the second field device. In particular, the logbook data located in the memory unit of the second field device can be output to the user or retrieved by the user only if the user successfully authenticates themselves to the second field device and/or if the user has a correct user role. Outputting can be carried out, for example, using storage media (e.g., a USB stick or similar) or using communication interfaces of the second field device.

The term “user” refers to both a human user and an electronic entity, for example a plant control center.

In an advantageous embodiment, it is provided that the second field device, which is temporarily or permanently connected to a WAN network and, when a WAN connection is available, transmits the accumulated logbook data securely (i.e., after authentication, and/or in an integrity-checked and encrypted manner) to a server application, for example on request or in a preconfigured time grid. This communication is advantageously carried out via a unidirectional telegram in order to be able to work with WAN connections with a “data diode” provided for security reasons. This can be achieved, for example, in that the sending field device cryptographically signs the logbook data and that the recipient implements signature verification. Such a method also makes alternative unidirectional data connections possible, for example using USB sticks or SD cards as data carriers. Advantageously, the signature can be generated and verified using a private/public key pair. The advantage of an asymmetric signature is that the receiving server and the field device both only need access to a common certificate-issuing certificate authority of a PKI, and unidirectional communication from the field device to a central server is sufficient otherwise.

Furthermore, the object is achieved by a system which comprises one or more first field devices of automation technology and a second field device of automation technology, wherein each of the first field devices is integrated in an automation network via a corresponding first communication interface and is designed to record measured variables relating to a process engineering process and to transmit them via the automation network and/or to receive control variables relating to the process engineering process, wherein each of the first field devices has a first resource power, wherein the second field device has a second resource power, wherein the second resource power is greater than each of the first resource powers, wherein each of the first field devices is designed to continuously generate logbook data, wherein the logbook data contain security-relevant data and/or data relating to the operation of the corresponding first field device, establishing a communication link between one or more of the first field devices and the second field device, wherein each of the first field devices is designed to transmit its current logbook data to the second field device at predetermined times via a secure communication link, which is established via the first communication interface via the automation network or via a second communication interface of each of the first field devices via a further network, wherein the second field device is designed to accumulate the current logbook data and to store the accumulated logbook data in a memory unit, in particular a persistent memory, of the second field device.

In an advantageous embodiment of the system, it is provided that the second field device is designed to create and accumulate its own logbook data and to store these data in the memory unit at regular intervals.

In an advantageous embodiment of the system, it is provided that the second field device is also part of the automation network and is designed to record measured variables relating to a process engineering process and to transmit them via the automation network and/or to receive control variables relating to the process engineering process. In this case, it can be provided that the functionalities of receiving the current logbook data of each of the first field devices, accumulating the received current logbook data, and storing the received logbook data are implemented by an additional module, which additional module is connected to the second field device.

In an alternative embodiment of the system, it is provided that the second field device is a network device, in particular a gateway, switch or edge device, a control unit, or a PC.

An advantageous embodiment of the system additionally comprises a cloud-based platform, wherein the second field device is designed to transmit the accumulated logbook data contained in the memory unit to the cloud-based platform, in particular via the Internet. A cloud-based platform is a server or server system that can be contacted via a WAN network and on which one or more applications can run that, for example, allow storing and/or processing of the logbook data.

The invention is explained in greater detail with reference to the following figure. In the figure:

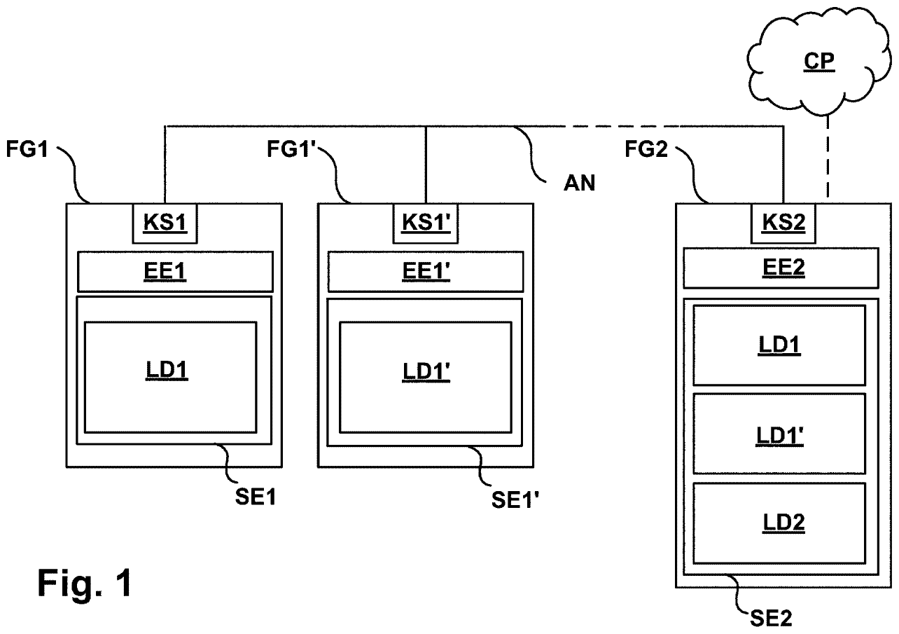

FIG. 1 shows an exemplary embodiment of the method according to the invention.

FIG. 1 shows an automation network AN. Two first field devices FG1, FG1′ and a second field device FG2 are integrated in this automation network AN. Of course, in addition to these field devices FG1, FG1′, FG2, a multiplicity of further field devices can also be integrated in the automation network AN. The first field devices FG1, FG1′ are, for example, measuring devices for recording process variables of a process engineering process. The second field device FG2 is, for example, a data recorder, a network device, in particular a gateway, switch or edge device, a control unit, or a PC.

Each of the field devices FG1, FG1′, FG2 has resources in the form of at least one electronic unit EE1, EE1′, EE2, at least one communication interface KS1, KS1′, KS2, and at least one memory unit SE1, SE1′, SE2.

The resource power of the second field device FG2 is higher than that of the first field devices FG1, FG1′. This means that at least one of the resources of the second field device FG2 has a greater power than the corresponding resource of the corresponding first field device FG1, FG1′. For example, greater power in a memory unit means that there is more storage space. For example, greater power in an electronic unit means that it has greater computing power. For example, greater power in a communication interface means that it can receive and transmit a higher data rate. For example, greater power in a key store means that it has a higher level of read protection.

Each of the field devices FG1, FG1′, FG2 continuously collects logbook data LD1, LD1′, LD2. These logbook data LD1, LD1′, LD2 contain, among other things, safety-relevant data (e.g., configuration or user information) and/or data relating to the operation of the corresponding field device FG1, FG1′, FG2, for example operating hours, or similar. The logbook data are stored in the corresponding memory units SE1, SE1′, SE2 of the corresponding field devices FG1, FG1′, FG2. Although the storage requirement per generated logbook data LD1, LD1′, LD2 is not too large (e.g., 10 kilobytes), the continuous generation (e.g., every minute) results in a data volume that cannot be stored on the memory units SE1, SE1′ of the first field devices FG1, FG1′. Reading this amount of data from the first field devices FG1, FG1′ is only possible with restrictions due to their slow communication interfaces KS1, KS1′.

The first field devices FG1, FG1′ are therefore designed in such a way that the logbook data LD1, LD1′ are continuously transmitted to the second field device FG2. For this purpose, a secure communication link is established between each first field device FG1, FG1′ and the second field device FG2 via the automation network AN. It is also possible, if the first field devices FG1, FG1′ have additional communication interfaces (e.g., wired or wireless) in addition to the communication interface used for the connection to the automation network AN, to establish the communication link for the logbook data via these interfaces (and not by means of the automation network AN).

For the secure communication link, the communication link is authenticated and, if appropriate, encrypted using, for example, a key-based trust relationship between the second field device FG2 and the corresponding first field device FG1, FG1′. The trust relationship can be based on the use of a symmetric key known to both sides. Alternatively, the trust relationship can be based on two asymmetric key pairs, with each communication partner being given the public key in addition to their own private key. A checksum can also be appended to the logbook data LD1, LD1′, wherein the second field device FG2 accepts the received logbook data LD1, LD1′ only if the checksum is plausible.

The advantage of using asymmetric keys is that the administrative effort can be reduced by using a so-called public key infrastructure, in which a certificate-issuing authority confirms the trustworthiness of communication partners with a public key PKa via an associated certificate signed by the certificate-issuing authority. When using such a PKI, the trust relationship between the communication partners can be traced back to a certificate-issuing authority that is mutually recognized as trustworthy.

The amount of the logbook data LD1, LD1′ to be transmitted is so small that this task can be easily performed by the communication interfaces KS1, KS1′ of each of the first field devices FG1, FG1′.

The second field device FG2 receives the corresponding logbook data LD1, LD1′, aggregates them and stores them in its memory unit SE2. The second field device FG2 can also generate its own logbook data LD2, which are then additionally stored in the memory unit SE2. The memory unit SE2 of the second field device FG2 is so large that the logbook data LD1, LD1′ can be stored over a longer period of time. Furthermore, the field device FG2 can provide the logbook data LD1, LD1′ with a checksum on the basis of the key information stored in the FG2, wherein the advantage is that the field device FG2 can better protect the keys used for this purpose against being read (when using special secure element chipsets) or can use more computationally intensive but better-protected methods (e.g., post-quantum algorithms).

Various methods can be used for the secure communication link for exchanging the logbook data LD1, LD1′ between field devices FG1, FG1′ and FG2:
In a first embodiment, the exchange takes place by establishing a secure connection in the sense of a cryptographically secured end-to-end connection (for example, using the TLS protocol) between FG1, FG1′ and FG2, in which the logbook data LD1, LD1′ are subsequently transmitted. In this embodiment, the data integrity check by the field device FG2 is based on the protection provided by the end-to-end connection, on the key negotiated for this connection, and on the integrity check, integrated in the end-to-end connection, of the transmitted useful data.
In an alternative embodiment, the field device FG1, FG1′ first adds a first checksum to the logbook data, for example on the basis of a symmetric key stored there (e.g., the secret-key algorithm HMAC-SHA256 according to RFC4688), and transmits them to the field device FG2 without further protection, possibly even without using end-to-end encryption. In this case, the integrity check is carried out by the field device FG2 by checking the first checksum.

It is important that the field device FG2 aggregates data in its memory unit SE2 only if the check is completed successfully.

The logbook data LD1, LD1′, LD2 stored in the second field device can be retrieved by a user (e.g., via an operating unit that communicates with the second field device FG2 wirelessly or via a wired connection). It can also be provided that the second field device FG2 transmits the logbook data to a cloud-based platform CP via the Internet (or a similar suitable connection) at regular intervals and/or at predetermined times on the initiative of a user.

### List of Reference Signs

AN Automation network

CP Cloud-based platform

EE1, EE1′, EE2 Electronic units

FG1, FG1′, FG2 Field devices

KS1, KS1′, KS2 Communications interfaces

LD1, LD1′, LD2 Logbook data

SE1, SE1′, SE2 Memory units

1-17. (canceled)

18. A method for documenting logbook data by one or more first field devices, wherein each of the first field devices has a first resource power, wherein a second field device is provided with a second resource power, wherein the second resource power is greater than each of the first resource powers, wherein each of the first field devices continuously generates corresponding logbook data, wherein the logbook data contain security-relevant data and/or data relating to the operation of the corresponding first field device, the method comprising:
establishing a secure communication link between one or more of the first field devices and the second field device;
transmitting the current logbook data from the first field device or each of the first field devices continuously or at predetermined times via the communication link;
accumulating the current logbook data by the second field device and storing the accumulated logbook data in a memory unit of the second field device.

19. The method according to claim 18, wherein the secure communication link is implemented based on a key.

20. The method according to claim 19, wherein a symmetric key pair is used for the secure communication link for each first field device, wherein in each case one of the keys of the corresponding symmetric key pair is located on the corresponding first field device and the other key of the symmetric key pair is located on the second field device.

21. The method according to claim 19, wherein, for the secure communication link, an asymmetric key pair consisting of a private key and a public key is used for each first field device, wherein in each case the private key of the corresponding symmetric key pair is located on the corresponding first field device and the public key of the symmetric key pair is located on the second field device.

22. The method according to 19, wherein the secure communication link is established by using a public key infrastructure.

23. The method according to claim 18, wherein each of the first field devices provides its current logbook data with a checksum before the transmission to the second field device, which checksum is calculated from the current logbook data.

24. The method according to claim 23, wherein the second field device aggregates the received current logbook data of each of the first field devices only if the checksum can be successfully verified.

25. The method according to claim 18, wherein the logbook data located in the memory unit of the second field device are output by the second field device to a user or are retrieved by a user from the second field device.

26. The method according to claim 25, wherein the logbook data located in the memory unit of the second field device can be output to the user or retrieved by the user only if the user successfully authenticates themselves to the second field device and/or if the user has a correct user role.

27. The method according to claim 18, wherein the logbook data located in the memory unit of the second field device are provided with an additional second checksum by the second field device.

28. The method according to claim 18, wherein the logbook data located in the memory unit of the second field device are output from the second field device to a cloud-based platform, wherein the field device and the cloud-based platform mutually authenticate each other by means of key information.

29. A system, comprising:
one or more first field devices of automation technology and a second field device of automation technology;
wherein each of the first field devices is integrated in an automation network via a corresponding first communication interface and is designed to record measured variables relating to a process engineering process and to transmit them via the automation network, and/or to receive control variables relating to the process engineering process;
wherein each of the first field devices has a first resource power;
wherein the second field device has a second resource power, wherein the second resource power is greater than each of the first resource powers;
wherein each of the first field devices is designed to continuously generate logbook data, wherein the logbook data contains security-relevant data and/or data relating to the operation of the corresponding first field device;
wherein each of the first field devices is designed to transmit its current logbook data to the second field device continuously or at predetermined times via a secure communication link, which is established via the first communication interface via the automation network or via a second communication interface of each of the first field devices via a further network;
wherein the second field device is designed to accumulate the current logbook data and to store the accumulated logbook data in a memory unit of the second field device.

30. The system according to claim 29, wherein the second field device is designed to create and accumulate its own logbook data and to store these data in the memory unit at regular time intervals.

31. The system according to claim 29, wherein the second field device is also part of the automation network and is designed to record measured variables relating to a process engineering process and to transmit them via the automation network and/or to receive control variables relating to the process engineering process.

32. The system according to claim 31, wherein the functionalities of receiving the current logbook data of each of the first field devices, accumulating the received current logbook data, and storing the received logbook data are implemented by an additional module, which additional module is connected to the second field device.

33. The system according to claim 29, wherein the second field device is a network device, in particular a gateway, switch or edge device, a control unit, or a PC.

34. The system according to 29, further comprising a cloud-based platform, wherein the second field device is designed to transmit the accumulated logbook data contained in the memory unit to the cloud-based platform, in particular via the Internet.
